(19) United States
(12) Patent Application Publication
(10) Pub. No.: US 2023/0088580 A1
(43) Pub. Date: Mar. 23, 2023

(54) ON-DEMAND TRANSMISSION OF A REFERENCE SIGNAL IN A DISCONNECTED MODE

(71) Applicant: Sony Group Corporation, Tokyo (JP)

(72) Inventors: Basuki PRIYANTO, Lund (SE); Nafiseh MAZLOUM, Lund (SE)

(21) Appl. No.: 17/794,980

(22) PCT Filed: Feb. 2, 2021
(86) PCT No.: PCT/EP2021/052410

§ 371 Date: Jul. 24, 2022

(30) Foreign Application Priority Data
Feb. 12, 2020 (SE) 2030045-5

(51) Int. Cl. H04L 5/00; H04W 52/02

(52) U.S. Cl. CPC H04L 5/0051; H04W 52/0229; H04W 76/28

(57) ABSTRACT

A method of operating a wireless communication device (101) includes obtaining configuration information indicative of a timing and a frequency of an on-demand transmission (450) of a reference signal (901, 4001) for use in a disconnected mode (302-303) of the wireless communication device (101). The method also includes, when operating in the disconnected mode (302, 303) using a discontinuous reception cycle (390) and in accordance with the timing and frequency: monitoring for the reference signal (901, 4001) of the on-demand transmission (450) transmitted by a communications network (100). The method furthermore includes, based on a receive property of the reference signal (901, 4001), attempting to demodulate a further transmission (980, 4002, 4011, 4012) from the communications network (100).

### TECHNICAL FIELD

Various examples generally relate to disconnected-mode operation of a wireless communication device. Various examples specifically relate to a transmission of a reference signal while the wireless communication device operates in the disconnected mode. Various examples specifically relate to an on-demand transmission of the reference signal.

### BACKGROUND

There is a need to reduce power consumption of wireless communication devices (UEs). One strategy to reduce power consumption of a UE is to operate the UE in a disconnected mode. As a general rule, the disconnected mode provides limited connectivity if compared to a connected mode, but enables a reduced power consumption. For example, in the context of the Third Generation Partnership Project (3GPP), example implementations of the disconnected mode include the Radio Resource Control (RRC) idle mode and RRC inactive mode.

As a general rule, when operating in the disconnected mode, the UE can expect transmissions from the communications network (NW) to be restricted to ON periods of a discontinuous reception (DRX) cycle; accordingly, during OFF periods of the DRX cycle, the UE can transition some parts of its wireless interface into an inactive state (the inactive state is also referred to as sleep state). For example, an analog front end and/or more parts of a digital front end can be shut down. This helps to reduce the power consumption.

In order to be able to receive data during the ON period of the DRX cycle, typically, the wireless interface is (re-)transitioned into an active state some time before the beginning of the ON period. This is because the transitioning from the inactive state to the active state requires some time and, furthermore, it is typically required to re-synchronize with the timing reference of the communications NW and/or otherwise adapt the wireless interface to be able to receive data, e.g., employing gain control, channel measurements, and channel estimation.

To re-synchronize, the UE can monitor for reference signals (RSs) transmitted by the communications NW when attempting to transition the wireless interface to the active state.

It has been found that the process of monitoring for the RSs can be comparably inefficient, particularly in transition to the active state, in that it requires significant time and consumes significant power.

### SUMMARY

Accordingly, there is a need for advanced techniques of operating UEs in the disconnected mode using a DRX cycle. In particular, there is a need for advanced techniques of re-acquiring synchronization with a communications NW prior to an ON period of the DRX cycle.

This need is met by the features of the independent claims. The features of the dependent claims define embodiments.

A method of operating a UE includes obtaining configuration information. The configuration information is indicative of a timing and a frequency of an on-demand transmission of a RS for use in a disconnected mode of the UE. The method also includes, when operating in the disconnected mode using a discontinuous reception cycle and in accordance with the timing of the frequency, monitoring for the RS of the on-demand transmission. The RS is transmitted by a communications network. The method also includes attempting to demodulate a further transmission from the communications network, based on a receive property of the RS.

A computer program or a computer-program product or a computer-readable storage medium includes program code. The program code can be loaded by at least one processor. Upon executing the program code, the at least one processor performs a method of operating a UE. The method includes obtaining configuration information.

The configuration information is indicative of a timing and a frequency of an on-demand transmission of a RS for use in a disconnected mode of the UE. The method also includes, when operating in the disconnected mode using a discontinuous reception cycle and in accordance with the timing of the frequency, monitoring for the RS of the on-demand transmission. The RS is transmitted by a communications network. The method also includes attempting to demodulate a further transmission from the communications network, based on a receive property of the RS.

A UE includes a control circuitry. The control circuitry is configured to obtain configuration information. The configuration information is indicative of a timing and a frequency of an on-demand transmission of a RS for use in a disconnected mode of the UE. The control circuitry is also configured to monitor for the RS of the on-demand transmission transmitted by the communications network, when operating in the disconnected mode using a discontinuous reception cycle. The control circuitry is configured to monitor for the RS in accordance with the timing and the frequency. The control circuitry is further configured to attempt to demodulate a further transmission from the communications network based on a receive property of the RS.

A method of operating an access node of a communications network includes obtaining configuration information. The configuration information is indicative of a timing and a frequency of an on-demand transmission of a RS. The configuration information is for use in a disconnected mode of a UE. The method further includes, when the UE operates in the disconnected mode in accordance with a discontinuous reception cycle, transmitting the RS of the on-demand transmission. Further, the method includes, upon transmitting the RS, providing a further transmission to the UE.

A computer program or a computer-program product or a computer-readable storage medium includes program code. The program code can be loaded by at least one processor. Upon executing the program code, the at least one processor performs a method of operating an access node of a communications network. The method includes obtaining configuration information. The configuration information is indicative of a timing and a frequency of an on-demand transmission of a RS. The configuration information is for use in a disconnected mode of a UE. The method further includes, when the UE operates in the disconnected mode in accordance with a discontinuous reception cycle, transmitting the RS of the on-demand transmission. Further, the method includes, upon transmitting the RS, providing a further transmission to the UE. An access node of a communications network includes a control circuitry. The control circuitry is configured to obtain configuration information that is indicative of a timing and a frequency of an on-demand transmission of a RS for use in a disconnected mode of a UE. The control circuitry is configured to transmit the RS of the on-demand transmission, when the UE operates in the disconnected mode and in accordance with the discontinuous reception cycle. Furthermore, the control circuitry is configured to provide a further transmission to the UE upon transmitting the RS.

A method of operating a UE includes obtaining configuration information. The configuration information is indicative of a timing and a frequency of an on-demand transmission of a RS for use in a disconnected mode of the UE. The method also includes, when operating in the disconnected mode using a discontinuous reception cycle and in accordance with the timing of the frequency, monitoring for the RS of the on-demand transmission. The RS is transmitted by a communications network. The RS is suitable for maintaining synchronization between the UE and the communications NW for a further transmission from the communications network.

A method of operating an access node of a communications network includes obtaining configuration information. The configuration information is indicative of a timing and a frequency of an on-demand transmission of a RS. The configuration information is for use in a disconnected mode of a UE. The method further includes, when the UE operates in the disconnected mode in accordance with a discontinuous reception cycle, transmitting the RS of the on-demand transmission. The RS is suitable for maintaining synchronization between the UE and the communications NW for a further transmission from the communications network.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular communications NW according to various examples.

FIG. 2 schematically illustrates multiple modes in which a UE connectable to the cellular communications NW can operate according to various examples.

FIG. 3 schematically illustrates aspects with respect to a DRX cycle that can be used by a UE when operating in a disconnected mode according to various examples.

FIG. 4 schematically illustrates a base station according to various examples.

FIG. 5 schematically illustrates a UE according to various examples.

FIG. 6 is a flowchart of a method according to various examples.

FIG. 7 is a flowchart of a method according to various examples.

FIG. 8 is a signaling diagram according to various examples.

FIG. 9 is a signaling diagram according to various examples.

FIG. 10 is a signaling diagram according to various examples.

FIG. 11 is a signaling diagram according to various examples.

FIG. 12 is a signaling diagram according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various aspects relate to a communication system. For example, the communication system may be implemented by a UE and an access node of a communications NW. For example, the access node may be implemented by a base station (BS) of a cellular communications NW (simply, cellular NW hereinafter). Hereinafter, for sake of simplicity various examples will be described in connection with an implementation of the communication system by a UE connectable to a cellular NW. However, similar techniques may be readily employed for other kinds and types of communication systems.

The communication system may include a wireless link between the UE and the BS. Downlink (DL) signals may be transmitted by the BS on the wireless link and received by the UE. Uplink (UL) signals may be transmitted by the UE and received by the BS.

Hereinafter, techniques will be described that facilitate operation of a UE in a disconnected mode. The disconnected mode may restrict connectivity, e.g., in terms of when the UE can receive data and/or in terms of what signals the UE can receive. The disconnected mode can generally enable a UE to shut down partly or fully one or more components of its wireless interface. When a UE operates in the disconnected mode, it is possible that the cellular NW discards certain information associated with the UE, e.g., certain information of the UE context, etc. It would be possible that a UE-specific data connection on the wireless link between the cellular NW and the UE is released. As a general rule, the UE operating in the disconnected mode can use a discontinuous reception (DRX) cycle, i.e., alternatingly switch the wireless interface between an active state and an inactive state. When in the inactive state, the wireless interface may be unfit to receive data. When switching from the inactive state to the active state, the UE may monitor for a RS. The ON period of the DRX cycle can be time-aligned with a paging occasion (PO). At the PO, the cellular NW can attempt to contact/page the UE, e.g., by transmitting one or more paging signals at the PO.

To be able to receive the one or more paging signals, the UE needs to be synchronized with the cellular NW. Sometimes, even if the UE previously obtained synchronization in a preceding ON period of the DRX cycle, depending on the length of the OFF period of the DRX cycle, the UE might lose its synchronization and therefore wake up in advance of the ON period to synchronize again by decoding a RS, before it can continue decoding the received data.

A RS generally denotes a signal that has a well-defined transmit property—e.g., amplitude, phase, symbol sequence, and/or precoding, etc.—that is also known to the receiver. Based on a receive (RX) property of the RS—e.g., based on the received amplitude or the received phase of the RS—it is then possible to tune one or more properties of the wireless interface. For instance, a radio-frequency oscillator may be tuned. Synchronization with the communications NW can be obtained. It would be possible to sound one or more channels (e.g., pertaining to different spatial streams) on the wireless link. Gain control to ensure the receive signal stays within a defined range is possible.

Various techniques described herein are based on the finding that in 3GPP Long Term Evolution (LTE), a so-called Common RS (CRS) is always transmitted. I.e., an always-on transmission of the CRS is configured. Hence, a UE can utilize the always-on transmission of the CRS for synchronization, gain control, and channel estimation in all UE modes, including the disconnected mode. In 3GPP NR, RSs, such as demodulation reference signal (DMRS) and channel state information reference signal (CSI-RS), are only transmitted when the UE is operating in the connected mode (but not when the UE operates in the disconnected mode); i.e., a sporadically-on transmission of the DMRS or CSI-RS is configured. When the UE is operating in the disconnected mode, the only RS that the UE can utilize is the Synchronization Signal Block (SSB) including a Primary Synchronization Signal (PSS) and a a secondary Synchronization Signal (SSS) which is periodically (e.g., every 20 ms) transmitted with limited bandwidth. Thus, there is an always-on transmission of the PSS. The UE may need to process multiple SSBs to perform gain control, synchronization, etc.

Then, the UE can attempt to demodulate a further transmission from the communications NW based on the RX property of the RS, i.e., upon synchronizing, etc. For example, the UE may attempt to demodulate a further transmission during or prior to the ON period of the DRX cycle.

Hereinafter, techniques are described that facilitate efficient—e.g., low-latency and/or energy-efficient and/or low-overhead—synchronization with the cellular NW. The efficient synchronization can be obtained through appropriate strategies for the transmission of the DL RS.

Some of the techniques described herein can be combined with wake-up signal (WUS) operation.

Here, a WUS is transmitted prior to a PO to inform UEs that there is at least one UE that will be paged at the PO. Then, at least one paging signal—e.g., a paging indicator and a paging message—can be transmitted at the PO. If the UE cannot detect WUS in a scheduled resources then the UE will not attempt to decode paging signal and may continue to stay in inactive state.

Therefore, by means of the WUS operation, the power consumption at the UE can be reduced.

Sometimes, a dedicated WUS receiver (typically referred to as wake up radio, WUR; sometimes also referred to as low-power receiver) is used detect the WUS. By means of the specific design of the WUR, it is intended to limit energy consumption.

Typically, a modulation scheme of the WUS is comparably simple. A simple waveform results in a WUS that may be detected comparably with a lower UE processing complexity than other signals such as data reception. In particular, a sequence-based WUS may be used. The waveform of such a sequence-based WUS may be detectable using time-domain processing. Synchronization (e.g., in time domain) between a transmitter and a receiver may not be required or can be coarse. Yet, in other examples, synchronization may be required, e.g., if the WUS is transmitted using a connection control channel that uses, e.g., Orthogonal Frequency Division Multiplex (OFDM) modulation. Then, frequency-domain processing is required, including demodulation and decoding.

In further detail, the WUS operation may, in some examples, help to avoid blind decoding of a control channel during a PO. Since typically such blind decoding is comparably energy inefficient, thereby, power consumption can be reduced by using WUSs. This is explained in greater detail hereinafter: For example, in the 3GPP scenario, during POs, the UE is expected to blind decode the control channel, specifically the Physical Downlink Control Channel (PDCCH). The blind decoding during the POs is for a paging radio NW temporary identifier (P-RNTI) as paging identity, typically transmitted in as a so-called paging indicator. If presence of a paging indicator including the P-RNTI is detected, the UE continues to decode a subsequent data shared channel (e.g., Physical Downlink Shared Channel, PDSCH) for a paging message. The blind decoding is comparably energy inefficient and can be conditionally triggered by means of the WUS operation. i.e., by a preceding WUS. In other examples, the WUS can also be transmitted on a control channel, e.g., PDCCH. This is sometimes referred to as PDCCH-based WUS.

According to various examples, an on-demand transmission of a RS is provided by the communications NW while the UE operates in the disconnected mode. Such operation in the disconnected mode can be combined with the WUS operation explained above.

As a general rule, the on-demand transmission of the RS is provided when required, i.e., can be labelled event-triggered. Thus, the on-demand transmission of the RS is not repeatedly provided according to a fixed timing scheme. The on-demand transmission may be at a fixed time/frequency relative to the trigger event. Thus, the UE cannot make an assumption on the presence of the RS of the on-demand transmission on the wireless link, unless detecting the trigger event. This is in contrast to a transmission of a RS that is in accordance with a certain fixed timing schedule (in such scenarios, in case the UE is aware of the timing schedule and the time and frequency of the respective transmission of the RS, and the UE can readily monitor for the respective RS, without a further trigger event being required).

In detail, the UE and the BS can respectively obtain configuration information indicative of a timing and a frequency of the on-demand transmission of the RS that may be available in the disconnected mode of the UE. Then, when operating in the disconnected mode in accordance with the DRX cycle, the UE can monitor for the RS of the on-demand transmission. The UE monitors at the timing and at the frequency indicated by the configuration information. Then, the UE can attempt to demodulate a further transmission from the communications NW during or prior to an ON period of the DRX cycle, based on a receive property of the RS.

The RS could be a Channel State Indication RS (CSI-RS), tracking RS (TRS) or a sequence-based reference signal (e.g., similar to a PSS or a secondary synchronization signal (SSS) or pseudo-random type sequences with non-coherent modulation). TRS is a special case of CSI-RS where there is a restriction in the transmit antenna port.

The timing and the frequency of the on-demand transmission of the RS may be tailored to the disconnected-mode operation of the UE. In particular, the timing and the frequency of the-demand transmission of the RS can be aligned with the further transmission prior to or during the ON period of the discontinuous reception cycle such that the time-to-synchronization before the further transmission can be reduced. This enables to reduce the power consumption of the UE.

As a general rule, such techniques of using an on-demand transmission of a RS may or may not be combined with WUS operation.

For example, in the first variant, the on-demand transmission of the RS may be combined with WUS operation. The WUS could be a PDCCH-based WUS such that, prior to monitoring for the WUS, synchronization between the UE and the communications NW is to be established based on a receive (RX) property of the RS.

Thus, in such a scenario, the on-demand transmission of the RS can be prior to the transmission of the WUS. The UE obtains gain control and synchronization based on the RX property of the RS prior to monitoring for the WUS. This is because PDCCH-based WUSs generally require frequency domain processing, demodulation and data decoding. Hence, a proper synchronization between the UE and the cellular NW is required.

In a second variant, WUS operation may be used, wherein a sequence-based WUS that can be received using time-domain processing (without requiring frequency-domain processing) is used. In such a scenario, the on-demand transmission of the RS can take place after transmission of the WUS. As the WUS is sequence-based, the WUS itself may be used for a coarse synchronization. A two-step synchronization between the UE and the communications NW can be performed, based on a RX property of the WUS providing coarse synchronization and a RX property of the RS of the on-demand transmission providing the fine synchronization. In such scenarios, it is possible that the on-demand transmission of the RS is triggered by communication of the WUS. For instance, the WUS could be indicative of the on-demand transmission being triggered. Thus, the on-demand transmission of the RS can be triggered explicitly or implicitly when a WUS is available for a given UE or multiple UEs. The on-demand transmission could be explicitly indicated in one of the information fields of the WUS. Such a scenario may correspond to multiple types of WUSs being available and by selecting the appropriate type of WUS, either triggering or not triggering the on-demand transmission of the RS. This helps to tailor resource management.

In a third variant, it is not required to combine the on-demand transmission of the RS with WUS operation. For instance, in a scenario where WUS operation is not enabled, the on-demand transmission of the RS can be transmitted prior to the ON period of the DRX and/or during the ON period of the DRX. Thus, in other words, the on-demand transmission of the WUS can be transmitted prior to the PDCCH-based transmission of the paging indicator and/or multiplexed with the PDCCH transmission of the paging indicator. Here, the PO itself can serve as the trigger for the on-demand transmission of the RS.

As will be appreciated from the above, various trigger events for the on-demand transmission of the RS are conceivable. An example trigger event includes communication of the WUS from a communications NW to the UE. Alternatively or additionally, a trigger event can include a predetermined time point before or after the beginning of the ON period of the DRX cycle. Yet another example trigger criterion includes transmission of an SSB within a predetermined time period prior to a PO of a given UE.

As explained above, the UE (as well as the BS) can obtain configuration information indicative of a timing and a frequency of the on-demand transmission of the RS. In detail, the configuration information could be indicative of time resources allocated to the on-demand transmission, frequency resources allocated to the on-demand transmission, or a combination thereof. The configuration information could also be indicative of at least one trigger event that triggers the on-demand transmission of the RS. Thus, the configuration information can specify the timing and frequency of the on-demand transmission of the RS.

As a general rule, there are various options conceivable regarding how to obtain the configuration information. The configuration information could be obtained from a local memory of the UE and the communications NW. Accordingly, it may not be required in all scenarios that the configuration information is signaled between the communications NW and the UE. For example, the configuration information may at least be partially obtained from a rule specified by a communications standard used for communicating on the wireless link between the UE and the communications NW.

But it would also be possible that the configuration information is at least partly obtained from a DL signal communicated from the communications NW to the UE. For instance, it would be possible that the DL signal is communicated when the UE operates in the connected mode, prior to the transition to the disconnected mode during which the on-demand transmission of the RS is used. For example, it would be possible that the DL signal encodes a connection deactivation message that triggers the transition to the disconnected mode. In such a scenario, the UE can be prepared for the disconnected mode operation using the on-demand transmission of the RS, in a context of the transition to the disconnected mode. In some examples, it would even be possible that the DL signal is the WUS associated with the ON period of the DRX cycle. In such a scenario, the configuration information may be provided directly before the on-demand transmission of the RS being triggered.

As a general rule, in some examples, the on-demand transmission may be statically activated. I.e., without further signaling, the UE may assume that the on-demand transmission is activated, i.e., directly triggered upon occurrence of the trigger event (if there is no trigger event, then the on-demand transmission is activated, but not triggered). In other examples, the communications NW may activate or deactivate the on-demand transmission. Activating and deactivating may pertain to informing the UE that it can expect the on-demand transmission of the RS or not. The communications NW may activate or deactivate the on-demand transmission, e.g., using a DL control message from the communications NW to the UE when the UE operates in the connected mode prior to the transition to the disconnected mode. The activation of the on-demand transmission of the RS may also be conditional on a capability of the UE to monitor for the RS of the on-demand transmission when the UE operates in the disconnected mode. Accordingly, it would be possible that an UL message is transmitted and/or received (communicated) from the UE to the communications NW, e.g., while the UE operates in the connected mode prior to the transition to the idle mode. The UL message can be indicative of the capability of the UE to monitor for the RS of the on-demand transmission when operating in the disconnected mode. The communications NW may selectively activate the on-demand transmission depending on the capability of the UE.

In some examples, it is possible that the monitoring for the RS of the on-demand transmission is conditional at the UE (i.e., even though the on-demand transmission is activated, and even though a trigger event is present or detected, the UE may decide to forgo monitoring for the RS of the on-demand transmission). For example, when operating in the disconnected mode, the UE may determine whether one or more predefined criteria are met. Then, the monitoring for the RS can be selectively executed depending on whether the one or more predefined criteria are met. Example predefined criteria include a cycle duration threshold for a cycle duration of the discontinuous reception cycle. I.e., it would be possible that the communications NW and the UE assume that the UE receives the RS of the on-demand transmission as an assistance whenever the UE sleep length/length of the OFF period within a DRX cycle is above a certain threshold. The cycle duration threshold could be determined considering a potential clock and frequency drift in the operation frequency and/or may depend on a numerology of the further transmission, e.g., a subcarrier spacing.

In addition to the on-demand transmission of the RS, there may also be a repetitive transmission of a further RS. The repetitive transmission of the further RS may not be conditional on a certain trigger event, but may be rather in accordance with a timing schedule. The on-demand transmission of the RS would then be superimposed/contemporaneous with the repetitive transmission. Thus, in principle, the UE may select to attempt to receive (monitor) the further RS of the always-on transmission and/or the RS of the repetitive transmission. Here, it would be possible that a bandwidth of the on-demand transmission of the RS is larger than a bandwidth of the repetitive transmission of the further RS. This means that the on-demand transmission may cover a broader frequency range of compared to the repetitive transmission. For instance, multiple RSs may be scattered across the broader bandwidth, or a single RS may occupy a comparably large bandwidth. Thereby, more accurate synchronization may be obtained by means of the on-demand transmission.

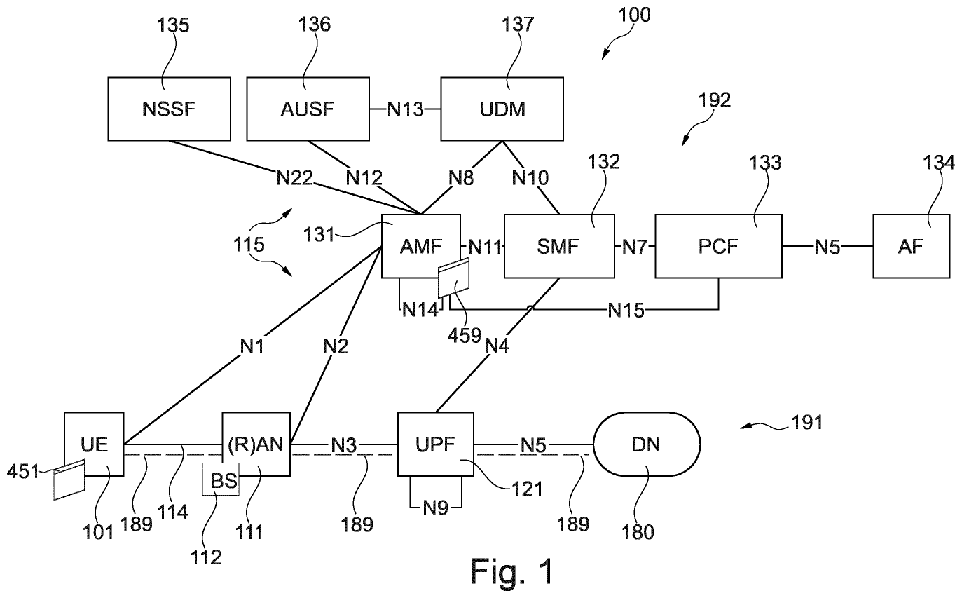

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, version 15.3.0 (2017-09). While FIG. 1 and further parts of the following description illustrate techniques in the 3GPP 5G framework of a cellular NW, similar techniques may be readily applied to other communication protocols. Examples include 3GPP LTE 4G—e.g., in the MTC or NB-IOT framework—and even non-cellular wireless systems, e.g., an IEEE Wi-Fi technology.

In the scenario of FIG. 1, a UE 101 is connectable to the cellular NW 100. For example, the UE 101 may be one of the following: a cellular phone; a smart phone; an IOT device; a MTC device; a sensor; an actuator; etc. The UE 101 has a respective identity 451, e.g., a subscriber identity.

The UE 101 is connectable to a core NW (CN) 115 of the cellular NW 100 via a RAN 111, typically formed by one or more BSs 112 (only a single BS 112 is illustrated in FIG. 1 for sake of simplicity). A wireless link 114 is established between the RAN 111—specifically between one or more of the BSs 112 of the RAN 111—and the UE 101. To perform channel sounding, it is possible to that the BS 112 provides one or more transmissions of one or more RSs. For example, the BS 112 can provide a repetitive transmission of a first RS, the repetitive transmission being always-on. The BS 112 can also provide on-demand transmission of a second RS.

The wireless link 114 implements a time-frequency resource grid. Typically, Orthogonal Frequency Division Multiplexing (OFDM) is used: here, a carrier includes multiple subcarriers. The subcarriers (in frequency domain) and the symbols (in time domain) then define time-frequency resource elements of the time-frequency resource grid. Thereby, a protocol time base is defined, e.g., by the duration of frames and subframes including multiple symbols and the start and stop positions of the frames and subframes. Different time-frequency resource elements can be allocated to different logical channels of the wireless link 114. Examples include: Physical DL Shared Channel (PDSCH); Physical DL Control Channel (PDCCH); Physical UL Shared Channel (PUSCH); Physical UL Control Channel (PUCCH); channels for random access; etc.

The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW 180, e.g., the Internet or a Local Area NW. Application data can be communicated between the UE 101 and one or more servers on the data NW 180.

The cellular NW 100 also includes a mobility-control node, here implemented by an Access and Mobility Management Function (AMF) 131 and a Session Management Function (SMF) 132.

The cellular NW 100 further includes a Policy Control Function (PCF) 133; an Application Function (AF) 134; a NW Slice Selection Function (NSSF) 134; an Authentication Server Function (AUSF) 136; and a Unified Data Management (UDM) 137. FIG. 1 also illustrates the protocol reference points N1-N22 between these nodes.

The AMF 131 provides one or more of the following functionalities: connection management sometimes also referred to as registration management; NAS termination for communication between the CN 115 and the UE 101; connection management; reachability management; mobility management; connection authentication; and connection authorization. For example, the AMF 131 controls CN-initiated paging of the UE 101, if the respective UE 101 operates in the idle mode. The AMF 131 may trigger transmission of paging signals to the UE 101; this may be time-aligned with POs. The timing of the POs can be determined based on the UE identity 451. After UE registration to the NW, the AMF 131 creates a UE context 459 and keeps this UE context, at least as long as the UE 101 is registered to the NW. The UE context 459 can hold one or more identities of the UE 101, e.g., temporary identities used for paging as described herein.

A data connection 189 is established by the SMF 132 if the respective UE 101 operates in the connected mode. The data connection 189 is characterized by UE subscription information hosted by the UDM 137. To keep track of the current mode of the UE 101, the AMF 131 sets the UE 101 to CM-CONNECTED or CM-IDLE. During CM-CONNECTED, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 and the RAN 111 and on to the UP 191 of the CN 115 and towards the DN 180. For example, a connection with the Internet or another packet data NW can be established. To establish the data connection 189, i.e., to connect to the cellular NW 100, it is possible that the respective UE 101 performs a random access (RACH) procedure, e.g., in response to reception of a paging signal or in response to UE-originating UL data being buffered for transmission. This establishes at least a RAN-part of the data connection 189. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the OSI model.

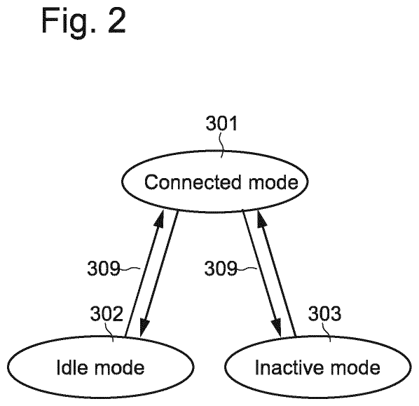

FIG. 2 schematically illustrates aspects with respect to multiple operational modes 301-303 in which a UE can operate.

The data connection 189 is established in the connected mode 301. In particular, a RAN-part of the data connection 189 is established in the connected mode 301. Data can be communicated between the UE 101 and the BS 112 using PDSCH, PDCCH, PUSCH, PUCCH. RRC control messages can be communicated on PDSCH and/or PUSCH. It is possible to use connected-mode DRX. The connected mode 301 can be implemented by the 3GPP RRC_Connected.

FIG. 2 also illustrates two disconnected modes 302-303. A first disconnected mode is the idle mode 302, e.g., implemented by 3GPP RRC_Idle. A second disconnected mode is the inactive mode 303, e.g., implemented by 3GPP RRC_Inactive. Typically, the inactive mode 303 is transparent to the CN 115, while the idle mode 302 may be signaled to the CN 115. Thus, the UE context 459 may be maintained at the CN 115 when the UE 101 operates in the inactive mode 303.

FIG. 2 also illustrates aspects with respect to the transitions 309 between the various modes 301-303. For instance, to trigger the transition 309 from the connected mode 301 to one of the disconnected modes 302-303, a connection deactivation message can be communicated, e.g., using RRC control signaling on the PDSCH or PUSCH. This may be a connection inactivate control message for the transition 309 to the inactive mode 303; or a connection release message for the transition 309 to the idle mode 302. The connection release message triggers release of the data connection 189. The connection deactivation message can include an information element that carries additional data.

The transition 309 from the idle mode 302 or the inactive mode 303 to the connected mode 301 includes a RACH procedure. The RACH procedure may be triggered by paging signals, e.g., a paging indicator on PDCCH and a paging message on PDSCH. In the inactive mode 303, paging can be triggered by the RAN; while in the idle mode 302 the paging is triggered by the CN.

The paging signals are transmitted at POs. The timing of the POs is determined depending on the identity 451 of the UE 101. The UE 101 can configure a DRX cycle in accordance with the timing of the POs. In particular, the UE 101 can control its wireless interface such that it is in the active state and ready to receive data—e.g., by blind decoding PDCCH for the paging indicator—at the start of the ON period of the DRX cycle.

The disconnected modes 302-303 may be combined with WUS operation. I.e., it is possible that a WUS is transmitted prior to the PO. The WUS may be transmitted on PDCCH or a distinct WUS channel. The WUS may be sequence-based for time-domain reception; or may require frequency-operation for reception using a synchronization with the cellular NW 100.

In some examples, it is alternatively or additionally possible to use WUS operation in the connected mode 301 employing DRX.

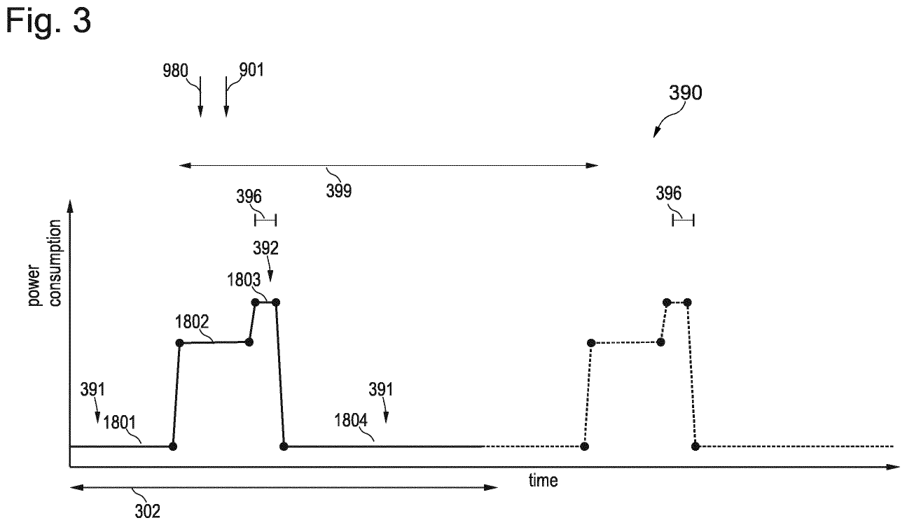

FIG. 3 schematically illustrates aspects with respect to a DRX cycle 390. The DRX cycle 390 can be used by the UE 101 in one or both of the disconnected modes 302-303, or even in the connected mode 301. FIG. 3 illustrates activity of the various components of the wireless interface of the UE 101 as a function of time, to implement a DRX cycle 390. More specifically, FIG. 3 illustrates the activity of the various components of the wireless interface by indicating the UE power consumption.

When using the DRX cycle 390, the UE 101 periodically transitions a modem of its wireless interface between an inactive state 391 (during time periods 1801 and 1804 in FIG. 3) and an active state 392 (during time period 1803 in FIG. 3). The time periods 1801 and 1804 correspond to OFF periods of the DRX cycle 390; and the time period 1803 corresponds to an ON period of the DRX cycle 390. The time period 1803 of the active state 392 is time-aligned with a PO 396 during which the cellular NW 100 can send the paging signal(s). FIG. 3 illustrates a corresponding cycle duration 399 of the DRX cycle 390, i.e., the periodicity or duration of individual periods of the DRX cycle 390.

The timing of the PO 396 is given (for the example of 3GPP NR) by (i) the System Frame Number (SFN) and (ii) the subframe within this frame and (iii) the UE_ID, which is derived from the respective identity 451 of the UE 101.

The UE 101 cannot receive paging signals when operating the modem in the inactive state 391; for example, an analog front end and/or a digital front end of the modem may be powered down. For example, amplifiers and analog-to-digital converters may be switched off. For example, decoding digital blocks may be switched off. For example, the UE 101 may be operated with a simple receiver that require low power consumption, such as operating in low sampling rate or not being capable of frequency-domain operation such as IFFT or FFT. The UE 101 hardware is entering the inactive state 391 when it is possible to save power. When the UE hardware is in the inactive state 391, one or more clocks may be turned off, all radio blocks and most modem blocks may be turned off, just minimum activity with a low frequency (RTC) clock to start the platform when it is time for the next PO 396 may be maintained. Accordingly, the inactive state 391 is associated with a comparably small power consumption.

When operating the modem in the active state 392, the UE 101 can monitor for paging signals. The various hardware components of the modem of the wireless interface are powered up and operating. For example, the UE 101 can perform blind decoding of the PDCCH to detect a paging indicator. The active state 392 is accordingly associated with a comparably high power consumption.

As illustrated in FIG. 3, there is a time period 1802 required to transition the UE 101 from the inactive state 391 to the active state 392 (wake-up time). This transition can require frequency and timing to be (re-)adjusted and the modem to be started to be able to receive paging signals. The UE 101 can receive one or more RSs 901 during the time period 1802, to (re-)synchronize. In FIG. 3, the UE 101 also receives a WUS 980 (albeit this is generally optional); while the WUS 980 is received prior to the RS 901, in other examples the RS 901 may be received prior to the WUS 980. Sometimes, it is even possible that synchronization is established based on the WUS 980, in which case it is not required to receive the additional RS 901. The RS 901 may be integrated into the WUS 980.

In the scenario of FIG. 3, the UE 101 does not receive a paging signal during the time period 1803; and, accordingly, transitions back into the inactive state 391 during the time period 1804. The procedure is repeated after the periodicity 399 of the DRX cycle 390 (as illustrated by the dashed line of FIG. 3). Once a paging indicator is detected, the UE 101 next reads a paging message on the PDSCH or a paging channel (PCH) (not illustrated). Based on the paging message, the data connection 189 can be set up, e.g., using a RACH procedure.

As will be appreciated from FIG. 3, the time period 1802 is significant. I.e., there is significant power consumption at the UE 101 to facilitate synchronization with the cellular NW 100 prior to the PO 396. Hereinafter, strategies are described that facilitate shortening the time period 1802 by fast synchronization. In particular, strategies are described that facilitate such shortening of the time period 1802 by providing a transmission of the RS 901 that facilitates fast synchronization during the time period 1802 prior to the PO 396.

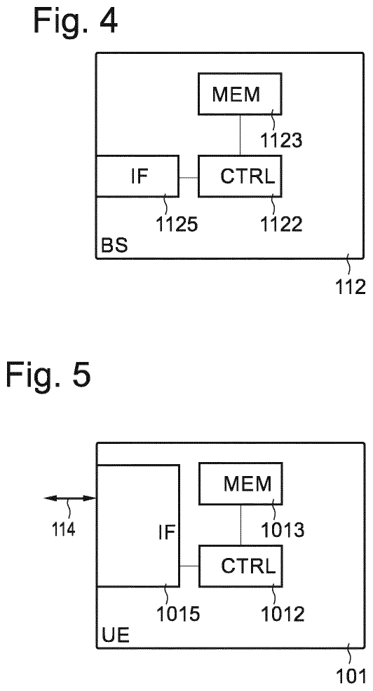

FIG. 4 schematically illustrates the BS 112. The BS 112 includes control circuitry 1122 that can load program code from a memory 1123. The BS 112 also includes an interface 1125 that can be used to communicate on the wireless link 114 with the UE 101 or nodes of the CN 115 of the cellular NW 100. As such, the interface 1125 can include an analog front end and a digital front end, as well as antenna ports, etc., for communicating on the wireless link 114. The control circuitry 1122 can load program code from the memory 1123 and execute the program code. Upon executing the program code, the control circuitry 1122 can perform techniques as described herein, e.g.: configuring and activating and providing a transmission of a RS, e.g., an on-demand transmission; receiving an indication of a capability of the UE 101 to monitor for a RS 901 of an on-demand transmission when operating in a disconnected mode 302-303; providing a configuration of a transmission of a RS to the UE 101; etc.

FIG. 5 schematically illustrates the UE 101. The UE 101 includes control circuitry 1012 that can load program code from the memory 1013. The UE 101 also includes a wireless interface 1015 that can be used to communicate on the wireless link 114 with the BS 112 of the cellular NW 100. As such, the wireless interface 1015 can include an analog front end and a digital front end, as well as antenna ports, etc. The control circuitry 1012 can load program code from the memory 1013 and execute the program code. Upon executing the program code, the control circuitry 1012 can perform techniques as described herein, e.g.: monitoring for a RS, e.g., when operating in a disconnected mode 302-303; transmitting an indication of a capability to the cellular NW 100 to monitor for a RS of an on-demand transmission when operating in a disconnected mode 302-303; obtaining a configuration of a transmission of a RS from the cellular NW 100 and monitoring for the RS in accordance with the configuration; controlling the wireless interface 1015 to switch between the inactive state 391 and the active state 392; operating in one of the modes 301-303; etc.

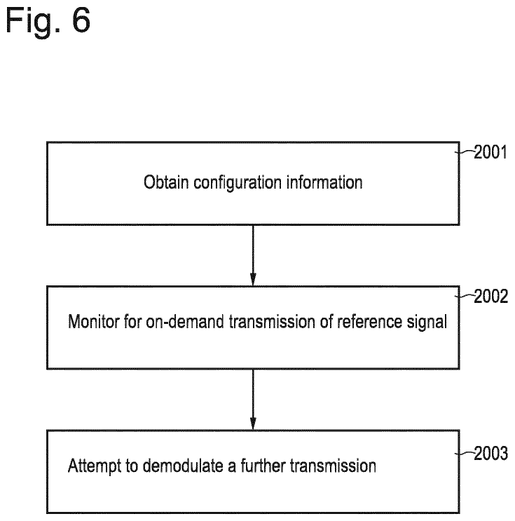

FIG. 6 is a flowchart of a method according to various examples. The method of FIG. 6 may be executed by a UE that can connect to a cellular NW. For example, the method of FIG. 6 could be executed by the UE 101. More specifically, it would be possible that the method of FIG. 6 is executed by the control circuitry 1012 of the UE 101 upon loading program code from the memory 1013.

For example, the method of FIG. 6 can be executed by a UE that can connect to a cellular network when operating in a connected mode. The method of FIG. 6 can at least partly be executed while the UE operates in a disconnected mode. Here, the data connection with the cellular NW can be released. It is possible that the method of FIG. 6 facilitates connectivity of the UE with the cellular NW, e.g., by helping the UE to acquire synchronization with the cellular NW.

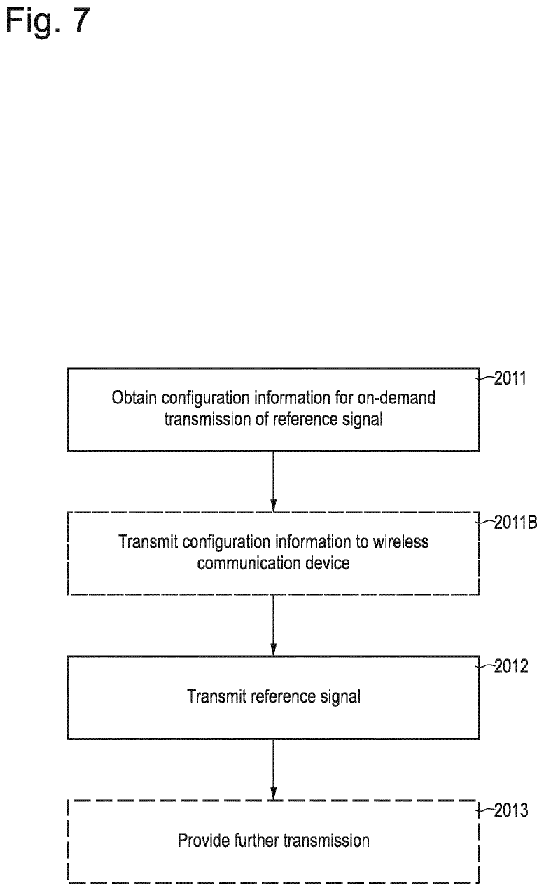

At box 2001, configuration information for an on-demand transmission of RS is obtained. In some embodiments the obtaining 2001 comprises retrieving information stored in the UE, e.g. during manufacturing and/or service and/or as part of a systems update. In some embodiments, the obtaining 2001 alternatively, or additionally, comprises receiving the configuration information from an access node; more specifically, data indicative of the configuration information may be received from the cellular NW (also see FIG. 7; box 2011B).

There are various options available for implementing the configuration information. Some of those options are illustrated in TAB. 1 below.

TABLE 1
Information elements specified by the configuration information
for the on-demand transmission

| | Implementation | |
|---|---|---|
| | of configuration | |
| Variant | information | Implementation |
| A | Activation or | The configuration information can indicate |
| | deactivation | whether the on-demand transmission of the |
| | of on-demand | RS is currently activated or deactivated. The |
| | transmission | configuration information could indicate an |
| | | activation time duration that indicates the time |
| | | duration for which the on-demand |
| | | transmission remains activated. |
| B | Timing and | The timing and the frequency of the on- |
| | frequency of | demand transmission can be specified so that |
| | on-demand | the UE knows how to monitor for the RS, upon |
| | transmission | detecting the trigger event. For instance, the |
| | | timing and the frequency may be indicated by |
| | | specifying time and/or frequency resources. |
| | | For instance, it would be possible that a |
| | | certain bandwidth part of a partitioned carrier |
| | | bandwidth of a time frequency resource grid is |
| | | specified. For instance, one or more resource |
| | | blocks including time-frequency resource |
| | | elements of the time frequency resource grid |
| | | may be specified. For instance, the |
| | | configuration information may relatively define |
| | | a least one of a timing or a frequency of the |
| | | on-demand transmission of the RS with |
| | | respect to a further timing or further frequency |
| | | of the further transmission. For example, a |
| | | time offset and/or a frequency offset of time- |
| | | frequency resources of the on-demand |
| | | transmission may be specified with respect to |
| | | time-frequency resources of the further |
| | | transmission or with respect to the trigger |
| | | event. It would be possible to specify a time |
| | | offset or a frequency offset, depending on the |
| | | circumstances. For instance, if the same |
| | | frequency as the further transmission is used, |
| | | then a time offset may be sufficient. |
| C | Trigger Event | It would be possible to specify one or more |
| | | trigger events that trigger the on-demand |
| | | transmission of the RS. Thereby, the cellular |
| | | NW can configure different triggers. For |
| | | instance, a first option for the trigger event |
| | | would be a time point before a PO. Another |
| | | second option for the trigger event would be a |
| | | WUS being received. |
| D | Quasi | It is possible to specify whether a quasi-co- |
| | co-location | location assumption is valid or not with respect |
| | indication | to a preceding transmission. |

In some embodiments, the configuration information implicitly defines at least one of the above-identified information elements of TAB. 1 in accordance with a lookup table or a derivation rule. For instance, it would be possible that depending on the particular trigger event that triggers the on-demand transmission of the RS, a respective timing or frequency is selected from the lookup table or derived from the derivation rule. For example, it would be possible that the configuration information is set in accordance with a device category of the UE. For instance, it would be possible that the timing of the on-demand transmission is set in accordance with a frequency of the further transmission.

In some embodiments, the configuration information is at least partly obtained from a rule specified for example by a communication standard. I.e., in such a scenario, it may not be required to receive a specific scheduling control message that is indicative of the timing and/or the frequency of the on-demand transmission; rather, the timing and/or frequency of the on-demand transmission may be specified by the communications standard. In other words, in some embodiments the configuration information comprises a rule known by both the UE and the NW.

In some examples, it is possible that the configuration information is at least partly obtained by receiving a DL signal received by the UE is communicated from the communications NW to the UE. In some examples, the DL signal can be communicated when the UE operates in a connected mode, i.e., prior to a transition to the disconnected mode. For instance, RRC control signaling may be used. It would be possible that the DL signal that is indicative of the configuration information encodes a connection deactivation message triggering the transition to the disconnected mode. More generally speaking it would be possible that the DL signal that is indicative of the configuration information is received a predetermined time before the transition from the connected mode to the disconnected mode.

In some examples, the DL signal is received while the UE operates in the disconnected mode. Here, it would be possible that the DL signal that is indicative of the configuration information is received a predetermined time prior to the ON period of the DRX cycle. For instance, the DL signal could be a WUS associated with the ON period of the DRX cycle. Here, it would be possible that the WUS includes an information field and the information field is indicative of the configuration information.

Next, at box 2002, the UE monitors for the on-demand transmission of the RS. This is in accordance with the configuration information, more specifically the timing and the frequency that is indicated by the configuration information. Box 2002 is executed while operating in the disconnected mode, e.g., in the idle mode 302 or the inactive mode 303. Accordingly, box 2002 is executed using a DRX cycle. Box 2002 can precede an ON period of the DRX cycle.

More specifically, at box 2002, the UE can detect a trigger event and then monitor for the RS in response to detecting the trigger event. The trigger event to monitor for could be specified in the configuration information (cf. TAB. 1, variant C).

The RS is suitable for maintaining synchronization between the UE and the cellular NW. This can be helpful for an optional further transmission, see box 2003. The synchronization can facilitate a reliable and robust demodulation of the further transmission. For this, an RX property of the RS can be considered, e.g., phase and amplitude. The RS may alternatively or additionally be suitable for maintaining gain control between the UE and the cellular NW.

The monitoring for the on-demand transmission of the RS can be facilitated by an appropriate receive operation for antenna array of a wireless interface of the UE. I.e., amplitude and phase of the various antenna elements of the antenna array can be appropriately selected. This is sometimes also referred to as monitoring using a given receive beam, i.e., a spatial characteristic of the reception sensitivity. Furthermore, this is sometimes also referred to as monitoring using a given channel property, such as Doppler spread/shift, average delay, delay spread, and/or average gain.

In particular, it is possible to select the receive operation using a so-called quasi-co-location (QCL) assumption with a preceding transmission. For instance, the preceding transmission may include a transmission during connected mode, prior to the transition to the sleep mode, e.g., on a PDSCH shared channel. Alternatively or additionally, the preceding transmission may include a transmission of a WUS or a further RS, e.g., a SSB.

As a general rule, two antenna ports are said to be quasi co-located if radio-channel properties of the channel over which a symbol on one antenna port is conveyed can be inferred from the channel over which a symbol on the other antenna port is conveyed. The radio channel properties which may be common across the antenna ports can be selected from: Doppler spread/shift, average delay, delay spread, average gain, and/or spatial receiver parameters.

Thus, the QCL assumption may require the transmitter, e.g., the BS, to use the same or QCL antenna ports for the on-demand transmission of the RS and the preceding transmission.

As a general rule, it would be possible that the QCL assumption is fixedly configured, e.g., in accordance with a communications standard. The QCL assumption may also be indicated in the configuration information of the on-demand transmission of the RS obtained at box 2001.

Next, at optional box 2003, an attempt to demodulate a further transmission is made, based on a least one RX property—e.g., phase and/or amplitude and/or timing of the RS, if received based on the monitoring at box 2002. For instance, an analogue receiver chain may be tuned based on time synchronization derived from a phase of the received RS, prior to attempting to demodulate the further transmission.

As a general rule, it would be possible that the further transmission includes a least one of a paging signal, a further RS, an always-on RS, or a WUS.

For instance, where the further transmission includes a further RS, e.g., an always-on RS, it is possible to perform a two-step synchronization with the communications NW based on—as a first stage—a RX property of the RS of the on-demand transmission, as well as—as a second stage—based on the always-on RS. Such a two-step synchronization can also be performed based on a WUS: it would be possible that the two-step synchronization with the communications NW is performed—as a first stage—based on the RX property of the RS of the on-demand transmission and—as a second stage—further based on the WUS. Thereby, a coarse synchronization obtained from the first stage is refined by a fine synchronization obtained from the second stage.

By using the on-demand transmission of the RS at box 2002, the time-to-synchronization can be reduced. Thus, referring to the example of FIG. 3, the time period 1802 may be shortened. UE power consumption can be reduced.

FIG. 7 is a flowchart of a method according to various examples. The method of FIG. 7 could be executed by an access node of a communications NW. For instance, the method of FIG. 7 could be executed by a BS of a cellular NW. For instance, the method of FIG. 7 could be executed by the BS 112 of the cellular NW 100 (cf. FIG. 1). More specifically, it would be possible that the method of FIG. 7 is executed by the control circuitry 1122 of the BS 112 upon loading program code from the memory 1123.

The method of FIG. 7 is generally interrelated with the method of FIG. 6. For example, the method of FIG. 7 can be executed aligned and inter-worked with the method of FIG. 6.

The method of FIG. 7 facilitates providing a transmission of a RS to a UE. In particular, it is possible that the transmission of the RS is provided while the UE operates in a disconnected mode, in which a data connection between the UE and the cellular NW has been released, e.g., at least along a wireless link between the UE and the cellular NW. It is possible that the UE previously operated in a connected mode, e.g., to obtain configuration information of the on-demand transmission of the RS.

At box 2011, the access node obtains configuration information for on-demand transmission of RS. The configuration information of the on-demand transmission specifies a timing and a frequency of the on-demand transmission. Box 2011 is interrelated with box 2001 (cf. FIG. 6).

There are various implementations conceivable for implementing said obtaining of box 2011. Some of these options are explained in connection with TAB. 2 below:

TABLE 2
Implementation variants of obtaining
configuration information at the BS

| | Implementation | |
|---|---|---|
| | of obtaining | |
| | configuration | |
| Variant | information | Explanation |
| A | The configuration | For example, it would be possible that the |
| | information is | configuration information is fixedly stored |
| | loaded from a | in the local memory. For example, the |
| | memory | configuration information can be stored in |
| | | the local memory by the manufacturer |
| | | and/or as part of a system update and/or |
| | | as part of an over-the-air configuration |
| | | process. |
| B | Determine the | For example, the configuration information |
| | configuration | can be determined based on one or more |
| | information | parameters such as category of the UE, a |
| | | respective request from the UE, and/or a |
| | | scheduling process taking into account, |
| | | e.g., a required timing, traffic load, |
| | | available resources, etc. |

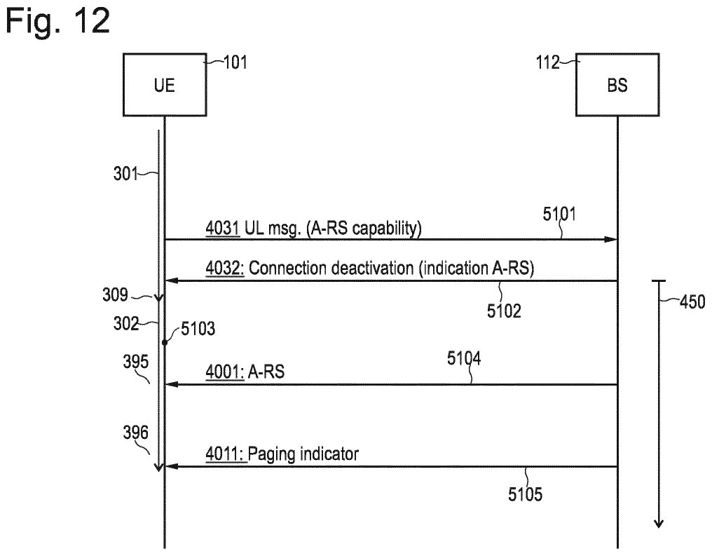

In some embodiments the method comprises, providing—at box 2011B—data indicative of the obtained 2011 configuration information to the UE. In other words, upon obtaining the configuration information—e.g., from a memory or upon determining, see TAB. 2—the configuration information may be indicated to a UE, as already explained in connection with FIG. 6 (also, cf. FIG. 12, 5102; TAB. 3). In other examples, the UE can independently obtain the configuration information, e.g., based on a predefined rule in accordance with a communications standard, etc.

At box 2012, the access node provides the on-demand transmission of the RS, i.e., transmits the RS in accordance with the timing and frequency of the on-demand transmission. The on-demand transmission is associated with a trigger event: upon the occurrence of the trigger event, the RS is transmitted at the timing and frequency of (i.e. indicated by) the configuration information. The on-demand transmission thus, generally, defines the framework of the transmitting of the RS.

Box 2012 can be implemented under consideration of a QCL assumption with another preceding transmission, e.g., a SSB, or a PDSCH transmission, or a WUS. This can imply using the same or comparable antenna ports or transmit beams for the transmission of the RS and the preceding transmission.

Any further transmission that may be provided can then be demodulated or at least attempted to be demodulated by the UE as the receiver of the on-demand transmission of the RS based on a RX property of the RS, i.e., amplitude and/or phase, etc. In some embodiments, the method comprises performing 2013 a further transmission to the UE.

In other words, 2012 and 2013 imply that the RS is suitable for (or configured to) enable the UE to obtain a synchronization level required to demodulate a further transmission (e.g., at box 2013) from the communications network (100), in particular when operating in the disconnected mode (cf. FIG. 2, idle mode 302 and inactive mode 303) using a discontinuous reception cycle (cf. FIG. 3).

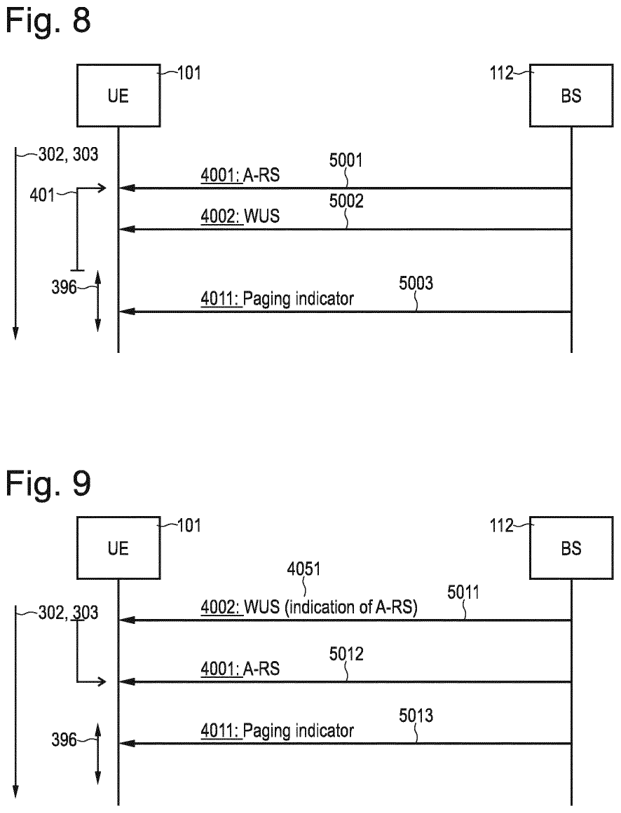

Next, in connection with FIG. 8 to FIG. 11, various scenarios for receiving the RS of the on-demand transmission will be explained.

FIG. 8 is a signaling diagram of communication between the BS of the cellular NW 100 and the UE 101. FIG. 8 illustrates aspects with respect to the on-demand transmission of the RS 4001, here, labelled as aperiodic RS (A-RS) 4001.

In the scenario of FIG. 8, the trigger event 401 for the on-demand transmission of the A-RS 4001 is a predetermined timepoint before the PO 396. The BS 112 transmits, at 5001 the A-RS 4001 at the timing and frequency specified by the configuration information that is, e.g., locally available to the UE 101 and the BS 112, e.g., based on a rule specified by a communication standard. It would also be possible that the timing and/or the frequency of the on-demand transmission of the A-RS 4001 is defined in accordance with a lookup table or derivation rule, depending on the paging occasion 396, i.e., depending on the identity 451 of the UE 101.

It would be possible that a receive operation, i.e., a receive beam, used for monitoring for the A-RS 4001 at 5001 is determined based on a QCL assumption for a preceding PDSCH transmission, prior to the transition 309 to the disconnected mode 302, 303 (not shown in FIG. 8). Another option would be to consider a preceding SSB reception (not shown in FIG. 8).

Upon receiving the A-RS 4001, the UE 101 receives a WUS 4002, at 5002. For example, a PDCCH-based WUS 4002 may be received, based on frequency-domain processing enabling blind decoding of the PDCCH. This is based on a synchronization between the UE 101 and the BS 112 facilitated by a RX property of the A-RS 4001. In some examples, based on a RX property of the WUS 4002, a fine synchronization, i.e., an adjustment of the coarse synchronization based on the A-RS 4001—can be facilitated, as part of a two-step synchronization.

Subsequently, during the PO 396, one or more paging signals 4011 are received, at 5003. For this, frequency domain processing such as blind decoding of the PDCCH can be employed. Thus, the synchronization based on the A-RS 4001 (and, optionally, the WUS 4002) can be used.

FIG. 9 is a signaling diagram of communication between the UE 101 and the BS 112. FIG. 9 illustrates aspects with respect to communication of the A-RS 4001 of the on-demand transmission. The scenario of FIG. 9 generally corresponds to the scenario of FIG. 8 in that both, the A-RS 4001, as well as a WUS 4002 are received prior to the paging occasion 396. The WUS 4002 can correspond to the WUS 980 of FIG. 3. However, in the scenario of FIG. 9, the WUS 4002 is received at 5011, i.e., prior to receiving the A-RS 4001 of the on-demand transmission at 5012.

More specifically, the on-demand transmission of the A-RS 4001 is triggered by an event 402 that corresponds to the reception of the WUS 4002 at 5011. It would be possible that the timing and the frequency is relatively specified by the configuration information with respect to the timing and the frequency of the reception of the WUS 4002 at 5011.

As illustrated in the example of FIG. 9, it is possible (but not mandatory) that the WUS 4002 includes an information element 4051 that is indicative of the A-RS 4001 being triggered. The A-RS 4001 can correspond to the RS 901 of FIG. 3. As such, different types of WUSs may be used, only some of which serve as the trigger event for the subsequent on-demand transmission of the A-RS 4001. Thus, for some POs the on-demand transmission of the A-RS 4001 may be triggered, while for other POs 396 the on-demand transmission of the A-RS 4001 may not be triggered. This may depend, e.g., on network load, etc.

Again, a two-step synchronization would be possible, based on the WUS 4002 received at 5011, as well as based on the A-RS 4001, received at 5012.

It would be possible that a receive operation, e.g., a receive beam, used for monitoring for the A-RS 4001 at 5012 is determined based on a QCL assumption for the WUS 4002 transmitted at 5011. Another option would be to consider a preceding SSB, in particular PSS or SSS reception (not shown in FIG. 8).

At 5013, during the PO 396, one or more paging signals 4011 are received, based on the preceding synchronization between the UE 101 of the BS 112 that is based on the A-RS 4001, and optionally on the WUS 4002.

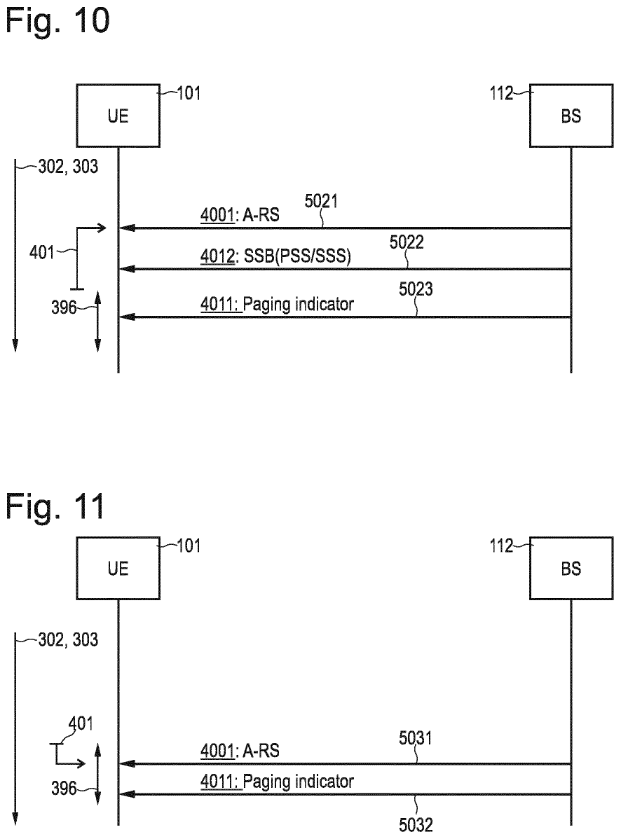

In FIG. 8 and FIG. 9, scenarios have been illustrated in which the on-demand transmission of the A-RS 4001 is combined with the WUS operation. It is not required in all scenarios to rely on WUS operation, as illustrated in connection with FIG. 10 and FIG. 11, below.

FIG. 10 is a signaling diagram illustrating communication between the UE 101 and the BS 112. FIG. 10 illustrates aspects with respect to the on-demand transmission of the A-RS 4001. The scenario of FIG. 10 generally corresponds to the scenario of FIG. 8 in that the A-RS 4001 is triggered by the PO 396. In particular, the timing and the frequency of the on-demand transmission of the RS could be relatively defined with respect to the PO 396 or the transmission of the paging signal 4011, at 5023. The PO 396 thus is a trigger event 401 for the on-demand transmission of the A-RS 4001 at 5021. Other trigger events are conceivable, e.g., the transmission of the paging indicator 4011 at 5023 or transmission of an SSB 4012 prior to the PO 396 at 5022.

In the scenario of FIG. 10, there is an optional transmission of the always-on PSS 4012 at 5022, included in the SSB. For instance, a two-step synchronization could be implemented based on a RX property of the A-RS 4001 of the on-demand transmission received by the UE 101 at 5021, and furthermore based on a further RX property of the PSS 4012 received by the UE 101 at 5022.

FIG. 11 is a signaling diagram of communication between the UE 101 and the BS 112. FIG. 11 illustrates aspects with respect to the on-demand transmission of the A-RS 4001. The scenario of FIG. 11 generally corresponds to the scenario of FIG. 10 in that the WUS operation is disabled. In the scenario of FIG. 11, the trigger event 401 of the on-demand transmission of the A-RS 4001 transmitted by the BS 112 at 5031 and received by the UE 101 at 5031 is, again, the PO 396 (but other trigger events are conceivable). In the scenario of FIG. 11, the A-RS 4001 is received during the PO 396, before transmission of the paging signal 4011 at 5032.

FIG. 12 is a signaling diagram of communication between the UE 101 and the BS 112. FIG. 12 schematically illustrates aspects with respect to the on-demand transmission 450 of the A-RS 4001.

In the scenario of FIG. 12, at 5101, the UE 101 transmits an UL message 4031 while operating in the connected mode 301. The BS 112 receives the UL message 4031. The UL message 4031 is indicative of the capability of the UE 101 to monitor for the A-RS 4001 of the on-demand transmission 450 when operating in the idle mode 302 (or the inactive mode 303). For example, the capability may be a one-bit flag or otherwise included in an appropriate information element of the UL message 4031. The UL message may be a RRC control message. The UL message 4031 may be communicated on the PUSCH on the wireless link 114. The UL message 4031 could be a connection deactivation request message.

Then, the BS 112 transmits a DL message 4032 at 5102—here, implemented by a connection deactivation message 4032. The connection deactivation message 4032 triggers the transition 309 from the connected mode 301 to the idle mode 302. The connection deactivation message is transmitted by the BS 112 at 5102 and received by the UE 101. The connection deactivation message 4032 can be transmitted in response to the UL message 4031 (accordingly, the UL message could be a connection deactivation request message). As a general rule, it would also be possible to use other DL messages, e.g., another RRC DL control message communicated on the PDSCH logical channel.

In the scenario of FIG. 12, the connection deactivation message 4032 is indicative of the on-demand transmission 450 being activated. This informs the UE 101 that the on-demand transmission 450 of the A-RS 4001 can be expected, each time a respective trigger event is detected.

Alternatively or additionally, it would be possible that the connection deactivation message 4032 is also indicative of a configuration information indicative of a timing and a frequency of the on-demand transmission 450 of the A-RS 4001. Thus, the connection deactivation message 4032 (on any other message used to transmit the configuration information) includes data that is indicative of the configuration information. For instance, the configuration information could be indicative of time resources allocated to the on-demand transmission 450 of the A-RS 4001, frequency resources allocated to the on-demand transmission 450 of the A-RS 4001, and/or at least one trigger event 401, 402 triggering the on-demand transmission 450, as previously explained in connection with TAB. 1.

TAB. 3 illustrates examples of implementation the data used to indicate the configuration information in a downlink message.

TABLE 3
Implementation variants of data
indicative of the configuration information

| | Implementation | |
|---|---|---|
| | of WUS | |
| | activation | |
| Variant | information | Explanation |
| A | derivation rule | Corresponds to implicit logic or |
| | | derivation rules so that the UE can |
| | | conclude on the configuration |
| | | information based on certain |
| | | parameters. |
| B | Explicit | Corresponds to an explicit indication of |
| | indication | the configuration information. For |
| | | example, time-frequency resources |
| | | may be directly specified, e.g., relatively |
| | | with respect to another transmission or |
| | | the PO. |
| C | index of a | Explicit indication, e.g., provided by the |
| | codebook of | cellular NW. The UE can be pre- |
| | candidate | provisioned with the various candidate |
| | configuration | configuration information included in the |
| | information | codebook and then select the |
| | | appropriate configuration information |
| | | from the codebook. |

Next, the UE 101 performs the transition 309 from the connected mode 301 to the idle mode 302 (while the scenario of FIG. 12 is explained in connection with operation of the UE 101 in the idle mode 302, likewise, the UE 101 could operate in the inactive mode 303 or another disconnected mode).

Then, one of the scenarios discussed above in connection with FIG. 8, FIG. 9, FIG. 10, and FIG. 11 can commence (in the scenario of FIG. 12, the scenario of FIG. 10 is illustrated, but other scenarios according to FIG. 8, FIG. 9 or FIG. 11 would be conceivable).

Thus, at 5104, the UE 101 monitors for the A-RS 4001 of the on-demand transmission 450 (now activated based on the connection deactivation message 4032; and triggered by an event, e.g., a timepoint prior to the PO 396, etc.). Then, at 5105, the BS 112 transmits the paging signal 4011 which is received by the UE 101.

In the scenario of FIG. 12, the UE 101, at 5103, determines whether one or more predefined criteria are met. Only in the affirmative, the UE executes the monitoring for the A-RS 4001 of the on-demand transmission 450. The one or more predefined criteria can enable the UE 101—that is, in principle, in possession of the configuration of the on-demand transmission 450 for the disconnected mode 302-303—to forgo the monitoring at 5104, even though the on-demand transmission 450 is currently activated.

When executing 5103, the connectivity of the UE 101—i.e., the ability to communicate with the cellular NW 100—is limited, if present at all. This is because there is no or only inaccurate synchronization. This has been explained in connection with FIG. 3: time period 1802. As such, the one or more predefined criteria can be such decision criteria that are primarily UE-centric. Thus, the UE 101 can be in a position to determine whether the one or more predefined criteria are met without receiving respective data from the cellular NW 100.

As a general rule, there are various options available to implement such one or more predefined criteria. Some of these options are described in connection with TAB. 5 below.

TABLE 5
options for predefined criteria for monitoring for
an on-demand transmission of RSs at the UE

| | Decision | |
|---|---|---|
| Variant | criterion | Remarks |
| A | Received | For example, the UE 101 may only attempt to |
| | signal | receive A-RS 4001 of the on-demand |
| | strength | transmission 450 if the received signal strength is |
| | threshold | above a certain received signal strength |
| | | threshold. For instance, it would be possible that |
| | | the received signal strength is determined based |
| | | on monitoring a further RS, e.g., a PSS or SSS of |
| | | an always-on transmission, received during the |
| | | same time period 1802 of the same period of the |
| | | DRX 390. In another example, it may be possible |
| | | to rely on a stored value of the received signal |
| | | strength from a previous ON period of the DRX |
| | | cycle. |
| B | Mobility | The mobility of the UE 101 may be compared with |
| | status | the mobility status threshold. For example, would |
| | threshold | be possible that the UE only attempts to receive |
| | | A-RS 4001 of the on-demand transmission 450 |
| | | when the UE 101 is static or has a comparably low |
| | | mobility. There are various options for |
| | | determining the mobility: some options may rely |
| | | on UE sensors, e.g., an accelerometer, etc. Other |
| | | options may rely on NW-assisted positioning or |
| | | satellite positioning. Also, see variant C of TAB. 5. |
| C | Cell | For instance, the UE 101 may check the cell |
| | identity | identity of a cell of the communications NW, e.g., |
| | | based on a received information block in the SSB. |
| | | The SSB can be received during the time period |
| | | 1802 of the same period of the DRX cycle 390. |
| | | For instance, based on a cell identity, the UE can |
| | | determine a mobility. For instance, the UE can |
| | | check whether it has moved to another cell since |
| | | the last ON period of the DRX cycle. For instance, |
| | | the UE could check whether it has moved to |
| | | another cell since last operating in the connected |
| | | mode 301. For instance, the UE may only attempt |
| | | to receive the A-RS 4001 if it is still within |
| | | coverage of the last serving cell while still |
| | | operating in the connected mode 301. |
| D | Cycle | The one or more predefined criteria may include |
| | duration | a cycle duration threshold for the cycle duration |
| | threshold | 399 of the DRX cycle 390. For instance, only if the |
| | | cycle duration 399 is below the cycle duration |
| | | threshold may the UE 101 attempt to monitor for |
| | | the A-RS 4001 of the on-demand transmission |
| | | 450. This is based on the finding that monitoring |
| | | for the on-demand transmission 450 of the RS |
| | | 4001 can be mainly beneficial if the UE 101 is |
| | | configured with a short cycle duration of the DRX |
| | | cycle. This is because the relative power |
| | | consumption for re-synchronization is comparably |
| | | large in such a scenario. |
| E | Threshold | For instance, the one or more predefined criteria |
| | traffic | may include a threshold traffic load. Only UEs |
| | load | having a comparably high data traffic may be |
| | | configured to monitor for the TRS. |

As a general rule, it would be possible to combine the various scenarios according to TAB. 5. For instance, a multiple decision criterion can be configured. It would be possible to configure a hierarchy between decision criteria, such that certain lower-hierarchy decision criteria need not be met, if higher-hierarchy decision criteria are met.

As a general rule, it would be possible that the one or more decision criteria are partly or fully configured by the NW, or are partly or fully configured by the UE. The one or more decision criteria may be fixed, e.g., according to a standard. When being configured by the communications NW, it would be possible to provide the respective decision criteria configuration information as part of the same DL message that activates the on-demand transmission 450 of the A-RS 4001 (e.g., connection deactivation message 4032).

Summarizing, above, various techniques have been described that facilitate configuring an on-demand transmission of a RS for a UE that operates in the disconnected mode. Such techniques can be generally combined with conventional always-on and repetitive transmission of RSs, e.g., an always-on transmission of PSS and SSS included in an SSB that is repeatedly transmitted by a cellular NW. For example, the UE can combine the reception of the RS of the on-demand transmission and the reception of the SSB or even replace the SSB reception with the RS of the on-demand transmission reception. For example, it may be possible to rely solely on the RS of the on-demand transmission when the UE is comparably static (i.e., has a low mobility level) and has a strong receive signal strength. Thereby, the power consumption at the UE can be reduced while not compromising the demodulation performance, e.g., when attempting to modulate the PDCCH in an ON period of the DRX cycle.

The configuration of such on-demand transmission can be done over RRC signaling, i.e. the NW and the UE agree that UE receives the RS of the on-demand transmission as an assistance whenever its sleep length within a DRX cycle is above a certain level. The threshold level can be determined considering the potential clock and frequency drift in the operation frequency and used OFDM numerologies. The decision criterion to monitor for the RS of the on-demand transmission can also depend on the NW resource occupancy.

The NW can enable/disable the activation of the on-demand transmission.

As part of such configuration, it can be possible to specify an event to trigger the on-demand transmission of the RS that can be used as an assistance for decoding data when synchronization is lost due to long sleep or drift.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various examples have been described in connection with scenarios in which the RS of the on-demand transmission is implemented by a TRS of a sequence-based RS. Respective techniques may be readily applied to other kinds and types of RS.

For further illustration, various examples have been described in connection with disconnected-mode DRX. Similar techniques may be applied to connected-mode DRX.

For still further illustration, various examples have been described which use a two-step synchronization. As a general rule, it would be possible that either the coarse synchronization and/or the fine synchronization is provided based on the on-demand transmission of the RS. For instance, in some examples, the coarse synchronization could be based on a WUS or a further RS, and the fine synchronization could be based on the RS of the on-demand transmission; but it would also be possible, vice versa, that the RS of the on-demand transmission is used for the coarse synchronization and the WUS or a further RS is used for the fine synchronization.

1. A method of operating a wireless communication device, the method comprising:
obtaining configuration information indicative of a timing and a frequency of an on-demand transmission of a reference signal for use in a disconnected mode of the wireless communication device,
when operating in the disconnected mode using a discontinuous reception cycle and in accordance with the timing and the frequency: monitoring for the reference signal of the on-demand transmission transmitted by a communications network, and
based on a receive property of the reference signal, attempting to demodulate a further transmission from the communications network.

2. The method of claim 1, wherein operating in the disconnected mode: determining whether one or more predefined criteria are met, wherein said monitoring for the reference signal is selectively executed depending on whether the one or more predefined criteria are met.

3. The method of claim 2, wherein the one or more predefined criteria comprise a cycle duration threshold for a cycle duration of the discontinuous reception cycle.

4. The method of claim 3, wherein the cycle duration threshold depends on a numerology of the further transmission.

5. The method of claim 1, further comprising:
detecting a trigger event and monitoring for the reference signal in response to said detecting of the trigger event.

6. The method of claim 1, wherein said monitoring for the reference signal uses a receive operation that is based on a preceding transmission from the communications network.

7. A method of operating an access node of a communications network, the method comprising:
obtaining configuration information indicative of a timing and a frequency of an on-demand transmission of a reference signal for use in a disconnected mode of a wireless communication device,
when the wireless communication device operates in the disconnected mode in accordance with a discontinuous reception cycle: transmitting the reference signal of the on-demand transmission, and
upon transmitting the reference signal: providing a further transmission to the wireless communication device.

8. The method of claim 7, wherein the configuration information relatively defines at least one of the timing or the frequency of the on-demand transmission of the reference signal with respect to a further timing or further frequency of the further transmission, or with respect to an event triggering the on-demand transmission.

9. The method of claim 7, wherein the configuration information implicitly defines at least one of the timing or the frequency of the on-demand transmission in accordance with a look-up table or a derivation rule.

10. The method of claim 7, wherein the configuration information is at least partly obtained from a rule specified by a communications standard.

11. The method of claim 7, wherein the configuration information is at least partly obtained from a downlink signal communicated from the communications network to the wireless communication device.

12. The method of claim 11, wherein the downlink signal is communicated when the wireless communication device operates in a connected mode, prior to a transition to the disconnected mode.

13. The method of claim 11, wherein the downlink signal encodes a connection deactivation message triggering a transition to the disconnected mode.

14. The method of claim 13, wherein the downlink signal is a wake-up signal associated with a paging occasion.

15. The method of claim 7, wherein the configuration information is indicative of at least one of time resources allocated to the on-demand transmission, frequency resources allocated to the on-demand transmission, or at least one event triggering the on-demand transmission.

16. The method of claim 7, wherein the on-demand transmission is triggered by at least one event, the at least one event comprising communication of a wake-up signal from the communications network to the wireless communication device.

17. The method of claim 16, wherein the wake-up signal is indicative of the on-demand transmission being triggered.

18. The method of claim 7, wherein the on-demand transmission is triggered by at least one event, the at least one event comprising a predetermined timepoint before or after a beginning of a paging occasion.

19. The method of claim 7, wherein the further transmission comprises at least one of a paging signal, a further reference signal, an always-on reference signal, or a wake-up signal from the communications network.

20-23. (canceled)

24. A wireless communication device comprising control circuitry configured to: —obtain configuration information indicative of a timing and a frequency of an on-demand transmission of a reference signal for use in a disconnected mode of the wireless communication device,
when operating in the disconnected mode using a discontinuous reception cycle and in accordance with the timing and frequency: monitor for the reference signal of the on-demand transmission transmitted by a communications network, and
based on a receive property of the reference signal, attempt to demodulate a further transmission from the communications network.

25-27. (canceled)
